(19) United States
(12) Patent Application Publication
(10) Pub. No.: US 2009/0293548 A1
(43) Pub. Date: Dec. 3, 2009

(54) DEVICE AND METHOD FOR PREPARING SILICEOUS MELTS

(76) Inventors: Thomas Niehoff, Markt Indersdorf (DE); Herbert Plaschke, Oberhausen (DE); Reinhard Jager, Bad Hersfeld (DE); Dirk Rogge, Amorbach (DE); Bernd Rudolph, Bad Hersfeld (DE)

Correspondence Address: The BOC Group, Inc., 575 MOUNTAIN AVENUE, MURRAY HILL, NJ, 07974-2082, US

(21) Appl. No.: 12/401,974

(22) Filed: Mar. 11, 2009

(30) Foreign Application Priority Data
Mar. 13, 2008 (DE) 102008014044.9

(51) Int. Cl. C03B 3/00

(52) U.S. Cl. 65/540

(57) ABSTRACT

Method and device for manufacturing siliceous melts to produce light-yellow mineral wool fibres using a cupola furnace includes (a) a charge including at least two different types of briquet, wherein chemical components take into account an anticipated proportion of iron, (b) the components of Al₂O₃ in the briquets are a supporting structure for the melting process, (c) a plurality of high temperature gas burners for heating, an arrangement of said gas burners chosen such that the burner flames reinforce each other, (d) collecting pan flared conically downwards from a mantle of a shaft in the furnace to a floor of the furnace.

There is currently an increased need for insulation material made from mineral wool. In order to create the fibres from which mineral wool is manufactured, mineral melts are used, and these are still produced in coke-fired cupola furnaces.

Cupola furnaces are shaft furnaces that were originally designed for use in metal foundries. Cupola furnaces are usually used for manufacturing cast iron. The design and function of the cupola furnace is very similar to that of the blast furnace, but it is considerably smaller, about 10 m high, and it does not reach the temperatures that are needed for melting out iron.

In order to start the furnace, a wood fire is lit in the base of the furnace, and then covered with coke. More recent designs are started with coal, which is heated to incandescence with gas burners. Then, the furnace is filled with several layers of metal and coke, onto which air is blown. With this method, the base of the furnace reaches temperatures up to 1600° C., which causes the metal to melt. The air that is blown onto the layers is supplied from the wind ring, and adding pure oxygen to this air may improve combustion and slightly lower the carbon content in the molten iron. A distinction is made between hot wind and cold wind cupolas depending on whether the air is heated before it is fed into the furnace.

The cupola furnace is charged with pig iron, scrap steel, recycled material, and industrial scrap iron. The carbon content in the molten iron is set by adjusting the relative quantities of scrap steel (low carbon content) and industrial scrap iron. Adding more coke also increases the carbon content. In addition, lime is added to neutralise the acidity of the slag and keep it more flowable.

In order to remove the metal, the furnace must be tapped slightly above its base. A siphon with two outlets is attached to the tap. The slag flows out of the top outlet and is transferred to a receptacle. The iron is forced out of the second outlet by the pressure of the slag above it, and may be transferred to a reserve furnace, for example. The siphon is only able to function with a slight overpressure.

Cupola furnaces being increasingly superseded by induction furnaces, since the latter produce less slag and waste, they are more versatile and they allow the composition of the molten product to be adjusted more precisely. However, induction furnaces can only be charged with pretreated scrap and are less economical than a large cupola furnace.

Advances in cupola furnace construction have resulted in furnaces that are fired by natural gas, known as cokeless cupola furnaces. These have a better thermal balance and significantly lower emission values.

In the conventional use of cupola furnaces to produce siliceous melts, basalt or a similar substance is used as the raw material. A pan is located at the bottom of the shaft to collect the melt. Farther up the shaft, there is a level in which the nozzles are arranged concentrically to blow air or oxygen into the furnace. A column of material (ballast) consisting of basalt blocks, lumps of coke and briquets stands in the pan. In this context, briquets may be made from return material, basalt granulate, additives, residue, waste or deposited materials.

At the very bottom of the pan is the iron melt, on top of that lies the mineral melt, up to a certain height below the nozzles. The melt can be drawn off through a siphon without becoming contaminated by the material in the column. The coal is burned and enables the melt to be produced at 1450° C.

Coke of the necessary quality for this process is often not available at all, or only in limited quantities, and the waste gases from the process are undesirable for environmental reasons.

There has been no shortage of attempts to use gas as the fuel. For this, the gas burners are arranged in the sides of the furnace chamber, roughly in the same place as the air inlets were previously. A grating is placed over them. Since there is no coke in the ballast on top of the grating, lumps of fire-resistant material, for example corundum (Al₂O₃), are introduced. These are prone to wear and must therefore be replenished regularly. The melt now drips through the grating.

A furnace for producing a melt that is used to manufacture mineral wool is known from German patent number DE 38 75 616 T2. The basic premise of this document is that minerals of silicon and metal oxides or carbonates and/or slag are used as the raw material for producing mineral wool. This raw material, which is mostly raw rock material of basalt or the diabase type, is generally melted in a water-cooled shaft furnace, and the melt is transferred to a spinning facility, which transforms the melt into fibres. In this case, a bonding agent is added during the spinning process and bonds the fibres together in a thermal treatment process to create a dimensionally stable product. Because of the coke that is mixed with the raw mineral material, the melt, which leaves the furnace at a temperature of about 1450° C., takes place in a reducing atmosphere. The escaping waste gases then typically contain 8 to 10% uncombusted carbon monoxide (CO) and a small quantity of hydrogen sulphide (H₂S) as well as sulphur dioxide (SO₂). The gas purification installation this necessitates, and the fact that the reducing atmosphere reduces the iron oxide in the raw material to metallic iron, which must be removed, are both seen as drawbacks of this process.

Other types of melting apparatuses such as crucible-type electric furnaces and furnaces with gas- or oil-heated crucibles are discussed with their respective advantages and disadvantages.

The object of the document cited above is to suggest a melting furnace for the production of mineral wool that is not harmful to the environment, yields a regular output whose temperature matches the final working temperature, offers acceptably low installation costs, and that may be adapted to discontinuous operation.

To solve this task, claim 1 of DE 38 75 616 T2 is based on a melting furnace including a shaft for holding and storing and melting the raw material to be melted, a water-cooled grating arranged in the base area of the shaft, which grating holds a layer of ceramic packing material and the raw material, a furnace chamber located below the shaft and having a base element for collecting the melt as it flows out of the shaft, and an outflow opening for discharging the melt, and a main burner disposed inside the furnace chamber.

In such a furnace, protection is essentially being sought for the fact that the melting furnace contains secondary burners above the grating in the lower area of the shaft, which are arranged adjacent the ceramic packing material to prevent channels from forming in the material to be melted, and that the base area of the furnace chamber is larger than the cross-sectional area of the shaft.

Even the use of secondary burners disclosed in this document does not produce sufficiently high temperatures, which results in a significantly cooler melt. However, higher temperatures are needed in order to manufacture the fibres. This may be achieved by connecting a collector to the pan of the shaft furnace or if the melt is passed through an additional electric arc furnace. When gas burners are used, an oxidising atmosphere is created, a significant quantity of iron melt is not produced.

As a result, when melt is produced with gas burners, the fibre that is manufactured is brown, whereas conventional processes produce pale yellow fibres.

However, brown fibres are not well received on the market and can only be used if they are laminated accordingly.

It is therefore the object of the device according to embodiments of the invention to present a cupola furnace with gas burners for producing mineral wool, which enables the manufacture of pale yellow wool and may also be used to produce glass wool. It is also intended that the construction of the device according to the invention also be granted such that old cupola furnaces may also be retrofitted in like manner.

The invention embodiments relate to a cupola furnace and a method for preparing siliceous melts in a cupola furnace that is charged solely with briquets. The term “briquets” is understood to mean synthetic blocks that have been manufactured for example by compressing of forming ground raw material. Such briquets may be for example pure aluminium oxide (Al₂O₃) briquets, aluminium oxide mineral briquets, or mineral briquets. The grain of the material in the briquets is for example smaller than 3 mm or smaller than 5 mm. The briquets are preferably spherical or cuboid, but other shapes are possible in accordance with the invention.

Unlike the methods commonly employed previously, in which the raw material to be melted, for example basalt, dolomite and/or other rocks, was added to the cupola furnace in the form of larger blocks or lumps, according to the invention the raw material must first be comminuted and shaped as a briquet. At first glance, this additional process step appears to be disadvantageous, but it yields significant advantages during the subsequent melting in the cupola furnace. In particular, the individual constituents of the raw material to be melted are distributed considerably more homogeneously in the briquets, and provide a much larger reaction surface than they would if they had been introduced into the cupola furnace as separate lumps of rock. This charging in briquet form according to the invention thus gives rise to a very homogeneous melt even in the cupola furnace. Accordingly, with the method according to the invention the cupola furnace may be charged with raw rock materials of lower quality without impairing the quality of the end product.

Besides the raw materials to be melted, the charge material for the cupola furnace also includes components consisting of aluminium oxide. Aluminium oxide only melts very slowly under the conditions prevailing in a cupola furnace. Therefore, briquets of aluminium oxide and/or briquets containing aluminium oxide are used as a support for the mineral components that are to be melted in the cupola furnace. Even so, the Al₂O₃ is also consumed gradually during the melting process, and fresh Al₂O₃ must be added to the cupola furnace periodically as part of the charging.

The term “aluminium oxide” includes crystalline Al₂O₃, particularly α-Al₂O₃, corundum and fire-resistant aluminium oxide compounds, such as chamotte or calcium aluminates in particular. On the other hand, the term “aluminium oxide” does not include the Al₂O₃ content in the mineral materials that are introduced into the cupola furnace for melting. For example, the Al₂O₃ content in basalts, dolomite, lime rock or clay minerals is explicitly not considered for these purposes. Compounds or mixtures of such kind are not fire-resistant aluminium oxide compounds and, as one skilled in the art is aware, they cannot be used as fire-resistant material. Aluminium oxide in crystalline form or as corundum is used particularly preferably.

In the following, the invention embodiments will be described with reference to the drawings.

In the drawings:

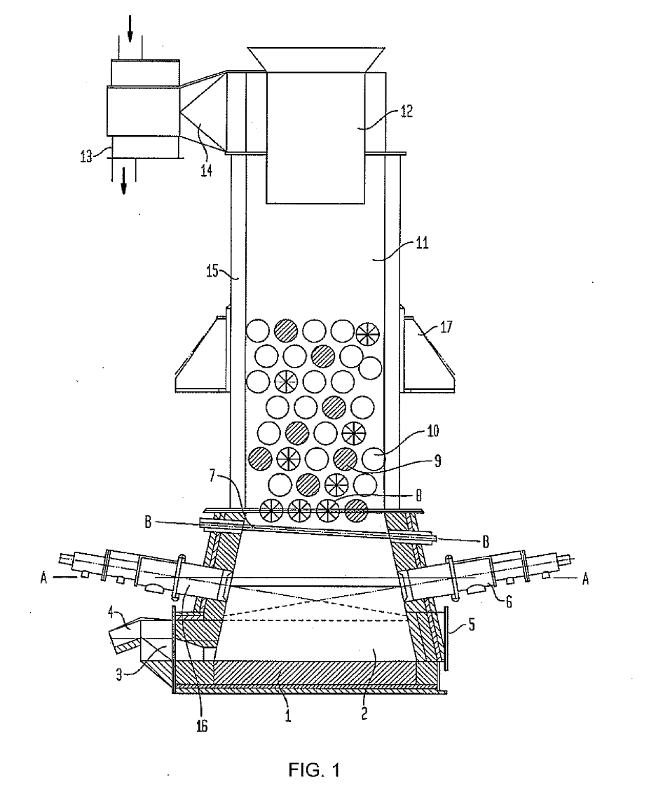

FIG. 1: is a cross section of a shaft furnace according to the invention;

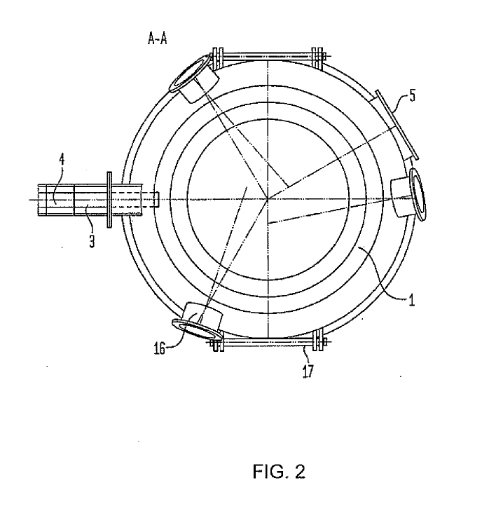

FIG. 2: shows the arrangement of burners according to the invention;

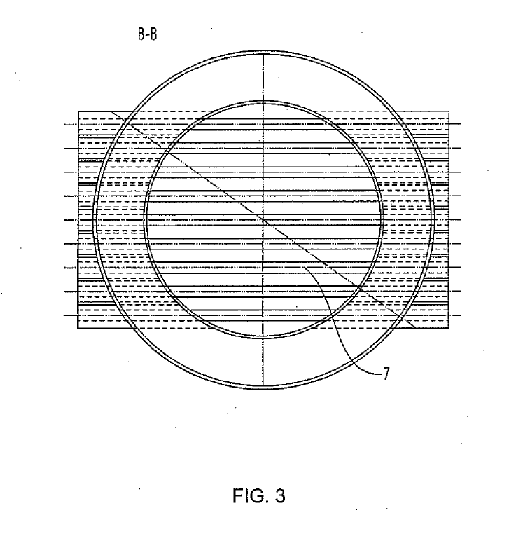

FIG. 3: is a sectional drawing of the area of the grating.

The cupola furnace shown in cross section in FIG. 1 essentially includes cylindrical mantle (15) of shaft (11), which stands on top of collecting pan (2), wherein this pan is flared conically downwards and the entire cupola furnace stands on furnace floor (1). Inclined collection grating (7) is shown in FIG. 1 in the connecting area between shaft (11) and collecting pan (2), and it is from here that the melt drips into collecting pan (2). The melt is to be removed through removal aperture or opening (4) via siphon (3) in the floor area of collecting pan (2).

The gas-oxygen burners (6) are also arranged at an angle to the longitudinal axis of shaft (11) since they are seated in the inclined wall of collecting pan (2). The exact position of these burners may be deduced from section A-A, which is shown in FIG. 2. Similarly, a plan view of collection grating (7) may also be deduced from section B-B in FIG. 3.

Aluminium oxide pellets (8), aluminium oxide-mineral briquets (9), and mineral briquets (10) have been represented in shaft (11) in FIG. 1 as an example of a certain form of furnace charging.

Waste gas channel (14) opens into filling opening (12), which is shown in the inlet area of shaft (11) in FIG. 1. The process heat that is removed via waste gas channel (14) is put to further use through heat exchanger (13). The stabilisers and retainers (17) are intended to provide mechanical support and stability for mantle (15) on shaft (11).

The arrangement of gas-oxygen burners (6) according to the invention may be deduced from section A-A in FIG. 2. Here, three burners (6) are shown for exemplary purposes to illustrate how burner holder (16) is installed with its axis at an angle relative to the diameter of collecting pan (2) such that the burner flames not only do not conflict each other, but actually reinforce each other. Siphon (3) with removal opening (4) is located in a favourable area with regard to the burner flames.

The gas burners (6) used are the most advanced design of high-temperature gas burners. They produce flame temperatures of about 1800° C., so that melt may be produced at 1450° C. without difficulty. When these burners are used, the melt output of the process is able to be controlled by means of the burner output, and the temperature of the melt may be controlled via the proportional content of oxygen at the burners.

FIG. 3 shows the pipes of collecting grating (7), through which a cooling agent flows, relative to the dimensions of mantle (15). The temperature and quantity of the coolant that flows through these pipes are controllable.

An essential feature of the cupola furnace according to the invention is the fact that shaft (11) is charged with briquets of various compositions to produce light-coloured wool. Since no iron is removed from the silicate melt by reduction, the chemical composition of the raw materials is adapted to take the lower iron content into account. According to the invention the charge material for the cupola furnace is no longer made up of random lumps of basalt, coke and briquets, but henceforth exclusively of briquets. In this way, the reduction of the iron is transferred to a preceding process by the process of manufacturing the briquets.

In this respect, a distinction is made between pure aluminium oxide briquets in pellet form (essentially composed of Al₂O₃), “aluminium oxide pellets” (8), aluminium oxide mineral briquets (9), and mineral briquets (10). The aluminium oxide mineral briquets (9) may consist for example of 50% basalt and 50% Al₂O₃, and the mineral briquets of 50% basalt and 50% siliceous material (other rocks, return material from the facility, other residue materials), which is enriched with alkaline oxides compared to basalt.

The essential function of the aluminium oxide pellets (8), which are composed mostly of Al₂O₃, the most important secondary component in this case being Cr₂O₃ (chromium oxide), or of the Al₂O₃ component in briquets, consists in that the Al₂O₃ takes on the function of a supporting agent throughout the melting process. Al₂O₃ is consumed slowly during the melting process, but overall it prevents the mineral components that are to be melted from passing through collection grating (7) before they are completely melted, because Al₂O₃ does not start melting until it reaches temperatures of about 2050° C.

The composition of the briquets (9,10) used in the melting process is dependent on the composition of the basalt used in each case.

The melting characteristics (plots of the liquid-solid curves) of the different briquets should be approximately similar, but they should melt at different temperature levels. The process may also be performed with only one type of briquet which has been optimised for the respective temperature and oxidation.

The term “basalt” here refers not only to the rock compositions of basalts and diabases of Central Europe, that may easily be optimised for idealised mineral wool melt compositions by modifying with carbonate rock and return material. After all, basalts and diabases of such kind are not found in other parts of the world, and as a result, other rocks with larger silicon dioxide components are used in many regions of the world. Modifications that must be made to all compositions, whether those described above or the easily modified basalt, are not discussed in the present disclosure. However, someone skilled in the art will be aware that such modifications must be made under corresponding circumstances.

In another embodiment of the invention, gas burners (6) may be arranged so as to be movable in the respective burner holders, and their positioning may be changeable in reproducible manner. The position of burners (6) may be controlled and monitored not only individually but also with regard to their interaction with the other burners (6). The position sensors and flame-optical monitoring sensors are familiar to those skilled in the art. According to the invention, a gimbal-type mounting is suggested for the mechanical design of movable burners (6). In this way, not only may the melting process be controlled, but the condition of the melt in collecting pan (2) may also be monitored and controlled.

A prerequisite for the composition of the briquet according to the invention is that the chemical composition of each new batch of basalt material must be determined, and the components of the briquets and their quantities relative to each other within the briquets must be selected on the basis of such determination.

In a further advance, according to the invention the raw materials, or briquets (8, 9, 10), are fed automatically or semi-automatically by means of a monitor-based supervision and control system. This automatic control of the entire melting process is founded on the output signals from the sensors for monitoring the entire melting process, such as are known to one skilled in the art. For this purpose, the parameters for the chemical components of the various batches of briquets used will be included in the control process in the same way as the parameters for waste gases and the temperature and colour of the melt fibres.

Of course, excess process heat is returned to the actual mineral fibre manufacturing process to the extent that this is financially justifiable. Thus for example the burner air may be preheated using excess process heat.

The method according to the invention enables savings to be made in terms of expensive coke, the entire facility may be shut off at will, and existing facilities may be retooled for this process without significant difficulties.

The method according to the invention is also suitable for producing glass melts to manufacture glass wool. In this case, one skilled in the art is aware that the facility requires a protective refractory lining and that the composition of the briquets has to be adapted accordingly, and that the melting temperature needs to be modified.

Special control software is required in order to be able to interactively control the current process parameters at the same time as analysing the components of the material batches used and assessing the quality of the mineral fibres obtained, as well as monitoring the signals from the sensors used.

### Legend

(1) Furnace floor
(2) Collecting pan
(3) Siphon
(4) Removal opening
(5) Assembly opening
(6) Gas-oxygen burner
(7) Collection grating
(8) Aluminium oxide pellets
(9) Aluminium oxide mineral briquet
(10) Mineral briquet
(11) Shaft
(12) Filling device/opening
(13) Heat exchanger
(14) Waste gas channel
(15) Mantle
(16) Burner holder
(17) Stabiliser and retainer

What is claimed is:

1. Cupola furnace for manufacturing siliceous melts to produce light-coloured mineral wool fibres, having the following features:
a) a charge including at least two different types of briquet, wherein chemical components take into account an anticipated proportion of iron,
b) the components of Al₂O₃ in the briquets are a supporting structure for the melting process,
c) a plurality of high temperature gas burners for heating, an arrangement of said gas burners chosen such that the burner flames reinforce each other,
d) collecting pan flared conically downwards from a mantle of a shaft in the furnace to the furnace floor.

2. Cupola furnace in accordance with claim 1, wherein the gas burners are arranged movably in holders.

3. Cupola furnace in accordance with claim 1, wherein the gas burners are arranged in a conically flared wall of the collecting pan, and wherein centre axes of the gas burners are inclined such that they form an angle of inclination from 8 to 12 degrees with a diagonal of a diameter of the collecting pan.

4. Cupola furnace in accordance with claim 3, wherein the angle of inclination of the centre axes of the gas burners is adjustable and reversible.

5. Cupola furnace in accordance with claim 1, wherein the charge comprises aluminium oxide pellets, comprising Al₂O₃, and briquets, the briquets comprising at least one of 50% basalt and 50% siliceous material such as rocks or return material which has been enriched with alkaline oxides compared with basalt, or 50% basalt and 50% Al₂O₃.

6. Cupola furnace in accordance with claim 1, wherein the charge comprises first briquets having a content of 100% basalt, and second briquets having a content of 50% basalt and 50% siliceous material which has been enriched with alkaline oxides compared with basalt.

7. Method for manufacturing siliceous melts to produce pale yellow mineral wool fibres in a cupola furnace, comprising:
a) charging the cupola furnace with at least two different types of briquet, wherein chemical components thereof take into account an anticipated proportion of iron, and wherein the components of Al₂O₃ in the types of briquet are a supporting structure for the melting process,
b) heating the cupola furnace with a plurality of high temperature gas burners, the gas burners being arranged such that the burner flames reinforce each other,
c) providing a collecting pan flared conically downwards to a floor of the cupola furnace for collecting melt from the furnace.

8. Method in accordance with claim 7, wherein the gas burners are arranged in a conically flared wall of the collecting pan, and wherein centre axes of each of the gas burners are inclined such that they form an angle of inclination from 8 to 12 degrees with a diagonal of a diameter of the collecting pan.

9. Method in accordance with claim 8, wherein the angle of inclination of the centre axes of the gas burners is adjustable and reversible.

10. Method in accordance with claim 7, wherein charging the cupola furnace is with aluminium oxide pellets and with aluminium oxide briquets and with mineral briquets, components of which comprise 50% basalt and 50% siliceous material such as rocks or return material, which has been enriched with alkaline oxides compared with basalt, or 50% basalt and 50% Al₂O₃.

11. Method in accordance with claim 7, wherein charging the cupola furnace is with first briquets having a content of 100% basalt, and with second briquets comprising 50% basalt and 50% other siliceous material such as rocks or return material that has been enriched with alkali oxides compared to basalt.

12. Method in accordance with claim 7, further comprising controlling at least one of burner position, burner output or oxygen content of burner feed air according to type, content and quantity of the different types of briquets.

13. Method in accordance with claim 7, further comprising performing the method steps on a computer with a program code for performing the method steps.

14. Method in accordance with claim 7, further comprising performing the method steps with a program code on a machine-readable carrier when the program is run on a computer.
